(19) United States
(12) Patent Application Publication
(10) Pub. No.: US 2004/0026908 A1
(43) Pub. Date: Feb. 12, 2004

(54) Elastic coupling component, individual spring

(75) Inventors: Joachim Schneider, Bad Soden-Salmunster (DE); Uwe Schleinitz, Nudersdorf (DE); Jurgen Weissbecker, Bad Soden-Salmunster (DE); Sabine Protzmann, Brachtal (DE)

Correspondence Address: BURNS, DOANE, SWECKER & MATHIS, L.L.P., P.O. Box 1404, Alexandria, VA, 22313-1404, US

(73) Assignee: WOCO AVS GmbH, Bad Soden-Salmunster (DE)

(21) Appl. No.: 10/459,484

(22) Filed: Jun. 12, 2003

(30) Foreign Application Priority Data
Jun. 12, 2002 (DE) 102 26 092.3

(51) Int. Cl. B60R 21/16

(52) U.S. Cl. 280/731

(57) ABSTRACT

Elastic coupling component part for connecting two component parts that are exposed to oscillations and/or vibrations during operation, in particular of a motor vehicle, preferably for forming connection between a steering wheel skeleton and a damper element. The coupling component part is comprised of an elastic body and of a mechanical fastening device that is to be allocated respectively to each component part and that is securely connected to the body.

This application claims priority under 35 U.S.C. §§119 and/or 365 to Patent Application Serial No. 102 26 092.3 filed in Germany on Jun. 12, 2002, the entire content of which is hereby incorporated by reference.

### BACKGROUND OF THE INVENTION

The invention relates to an elastic coupling component part or a single spring for connecting two component parts of an oscillating system, in particular of a motor vehicle, an apparatus with two component parts of an oscillating system, in particular of a motor vehicle, and a support for holding a component part to another component part, in particular of a motor vehicle, that is exposed to oscillations and/or vibrations.

The practice of connecting component parts in a manner that is springy and/or with elastic cushioning in order to absorb or dampen parasitic oscillations and vibrations is known in the art, in particular with regard to motor vehicles. In steering wheel apparatuses, a damper element is, for example, elastically connected to a stirring wheel skeleton.

According to German Patent No. 199 13 120, parasitic oscillations that occur in a steering apparatus of this kind are canceled due to the use of a gas generator 6′ of an airbag module 4′, 7′, 4″, 7″ as a damper element. In FIG. 1a of the steering wheel apparatus for motor vehicles, the gas generator 6′ is connected, based on this state of the art, via a spring lock washer 12′, which is comprised of an elastomer, to the support plate 11′. The support plate 11′, on its part, is securely connected to the steering wheel skeleton 2′ by way of the screwed connections 15′. In order to fasten the spring lock washer 12′ to the support plate 11′, the spring lock washer 12′ is vulcanized to the support plate 11′. In FIG. 1b, the gas generator 6″ is securely connected to the support plate 11″, which is fastened to the plate plates 13″, 14″ of the steering wheel skeleton 2″ via three elastomer tie-in bearings 18″ and a screw-bolt-connection 19″, 20″, while the spring has the ability to swing. Both coupling designs of the gas generator 6′, 6″ to the steering wheel skeleton 2′, 2″ are disadvantageous because of the extensive requirements for assembly and/or the large quantity of individual component parts. Preparatory adhesion-supporting steps must be implemented on the support plate 11′ and the spring lock washer 12′ in order to vulcanize the spring lock washer 12′ to the support plate 11′. These steps include pre-treating the adhesive surfaces as well as degreasing and applying a chemical solution and, finally, the vulcanization process itself. Moreover, the fastening method by way of vulcanization is disadvantageous due to the fact that it may easily entail hardening that can cause, when subjected to major stresses, the undesired detachment of the spring lock washer 12′ from the support plate 11′. In the coupling apparatus according to the prior art that is represented in FIG. 1b and comprised of the elastic tie-in bearing 18″ as well as the screw-bolt-connection 19″, 20″, which is spatially separate from the former, the assembly is extremely complex because many individual parts must be exactly positioned and the mutual interaction between the screw-bolt-connection 19″, 20″ and the elastomer tie-in bearing 18″ must always be taken into account.

The practice of installing a mounting cylinder made of an elastic material, which is arranged between the gas generator flange and the generator support in order to absorb the undesired vibrations on the gas generator, is known in the art from DE-299 02 033 (corresponding to Frisch U.S. Pat. No. 6,361,065). The mounting cylinder is attached by way of vulcanization to the corresponding component parts. But even with this elastic coupling, the disadvantages associated with the vulcanization process outlined previously continue to apply.

Publication US-2001-0048216 discloses an airbag model envisioning that one mounting plate is equipped with an opening for the folded airbag. A ring-shaped coupling component part comprised of an elastic material is vulcanized to the edge of the opening. The gas generator is fastened to the mounting plate utilizing a bayonet locking device, and the elastic, ring-shaped coupling component part is arranged between the mounting plate and the gas generator. This coupling apparatus requires, on the one hand, the disadvantageous vulcanization attachment process and, on the other hand, a very complex bayonet locking device rendering it necessary for the gas generator and the mounting plate to be correspondingly designed in order to realize the bayonet lock. The result are very high production costs of the gas generator as well as of the mounting plate.

DE-39 25 761 (corresponding to Kawaguchi et al. U.S. Pat. No. 5,024,464) discloses an airbag module with a vibration suppression apparatus between the airbag module and the steering wheel skeleton. To suppress vibrations, the gas generator is connected to the body of the steering wheel by way of an elastic coupling means. The elastic coupling means comprises a rivet both ends of which are inserted into the housing of the gas generator and/or the steering wheel part. Leaving a clearance, the rivet is surrounded by a tube-shaped elastic part, and the lower end of the elastic coupling part is connected for support reasons to a washer, which, in turn, is supported on the steering wheel part. This coupling arrangement also requires separate component parts rendering a subsequent complex assembly process necessary.

Finally, an airbag module that envisions a rubber ring between the airbag housing and the gas generator is known in the art from German Utility Patent No. 298 16 933. In order to attach the rubber ring to the gas generator, the latter features a slot that receives a fastening flange. Another flange of the airbag housing is arranged in such a way relative to the fastening flange of the gas generator that the rubber ring is compressed and thereby held in its position. This coupling apparatus is disadvantageous in that it requires exact mounting dimensions in order to ensure that the contact force of the flange of the airbag module housing is strong enough to prevent the rubber ring from slipping, while the contact force does not become too big, compromising the absorption properties of the rubber ring.

The object of the invention consists in creating a coupling component part that will allow for a quick, simple and, in particular, flexible assembly of vibrating component parts, that is devoid of any vulcanization process and avoids any compromising of the absorption properties of the coupling component part.

### SUMMARY OF THE INVENTION

The invention envisions an elastic coupling component part that comprises an elastic body and a mechanical fastening device, with the latter respectively to be allocated to a component part. The mechanical fastening devices are securely fastened to the body. The elastic coupling component part according to the invention connects two component parts that are exposed to oscillations and/or vibrations. The coupling component parts according to the invention have proved particularly advantageous with regard to motor vehicle component parts, for example, in the context of a damper element that is to be connected to the steering wheel skeleton.

The coupling component parts according to the invention can also be used as connecting parts to neutralize vibrations in order to create a neutralization unit such as the neutralization of the radiator or the neutralization of the gearshift.

With the coupling component part according to the invention, it is possible to realize oscillation systems that comprise, in terms of their constructive design, a high level of flexibility in order to realize the coupling of the parts that are to be connected. In particular, no further preparatory process steps are necessary for vulcanizing an elastomeric coupling component part to the component parts. Moreover, connecting the elastic component parts via a mechanical fastening device is considerably more reliable than creating a connection by way of vulcanizing.

In addition, the elastic coupling component part according to the invention is considerably more economical than the conventional coupling measures, specifically in terms of the complexity of assembly and manufacturing costs. The elastic coupling component part or the individual spring of the invention is, in particular, suited for single part manufacture and thereby the production of large quantities. Moreover, the coupling component part according to the invention represents a separation of the coupling elements that are usually manufactured in one piece with the component parts they are to be connected to. On the other hand, the separate coupling component part is a component part unit the assembly of which requires only a few further simple steps.

A further advantage of the coupling component part according to the invention can consist in the fact that the mechanical fastening device is detachably fastened to the respective component parts. Contrary to vulcanizing an elastic body to the respective component part, the coupling component part of the invention is preferably designed in such a way that it is detachably fastened to the corresponding component part. Thus, it is possible to realize disassembly and then re-assembly of the respective component parts, which in turn reduces the repair and replacement costs for individual component parts of the oscillation system. In conventional component sections that are realized in one piece with the component parts, as a matter of principle, the whole component part must be replaced if the elastic coupling fails.

Furthermore, the coupling component part can envision that the fastening device is designed to form a positive connection and/or a frictional or non-positive connection. These different mechanical types of connections allow for fastening the elastic body to the respective component part and/are able to take the place of any chemical coupling process, such as vulcanization.

Preferably, the fastening device is securely attached to at least one free end of the coupling component part or at least adjacent to one of the free ends. This arrangement of the fastening device simplifies an easy assembly of the coupling component part to the respective component part that is to be connected. Moreover, by arranging the fastening device in the proximity of the free end of the coupling component part, it is possible to expose the entire elastic body to the oscillations and/or vibrations, which results in the optimal utilization of the absorption properties of the coupling component part.

The mechanical fasting device can be realized by way of rivet element, tie-in element, lock element, clamp element, clip element or something similar.

In a first preferred embodiment of the coupling component part according to the invention, the fastening device is comprised of a rivet element. The rivet element creates a secure positive connection of the elastic body to the respective component part. To realize the rivet element, any rivet element component parts that are known in the art can be utilized. Preferably, the rivet element is glued or vulcanized to the elastic body. This fastening process can be carried out in a separate manufacturing process for the coupling component part prior to its final installation. But in an effort to simplify the installation of the rivet element, it is also conceivable to postpone fastening the rivet element until the exact position of the elastic body in relation to the component part that is to be connected has been determined. This way, it is possible to realize an even higher level of flexibility during the installation of the component part that is exposed to vibrations.

An advantageous rivet element is comprised of a metal, in particular of aluminum. Principally, the rivet element is to be designed in such a way that it is able to withstand the stresses generated during operation.

An alternative fastening device for the coupling component part according to the invention can envision a clip element at the end of the elastic body. The clip element is correspondingly designed to engage its allocated bore hole in the respective vibration component part forming a lock. Clip elements can be comprised of plastic, thereby allowing for easy fastening to the elastic body, for example by way of gluing.

In a further preferred embodiment of the coupling component part according to the invention, the fastening device is realized by way of an engagement section in the body. This engagement section is intended to act in conjunction with the clamp gripper or snapper, mounted correspondingly on the respective component part. The clamp gripper or snapper is designed in such a way that it is able to engage the engagement section. The engagement section can be securely mounted to the elastic body as an additional component part, or it can be created in one piece with the body as a section that is a realized, formed elastic section. Naturally, the engagement section must be designed as exhibiting suitable strength to withstand the stresses that are generated during operation in the connecting area between the engagement section and the clamp gripper. Moreover, it is conceivable to realize the engagement section on the respective component part that is to be connected and to fasten the clamp gripper or snapper to the body of the coupling component part. The clamp gripper or snapper is preferably comprised of a metal, in particular of aluminum.

Preferably, the body has a sleeve-like construction. This sleeve-like construction is to be chosen primarily in instances when the stresses acting upon the coupling component part occur lengthwise of the sleeve-like construction or when torsional forces act upon the coupling component part. In another preferred embodiment of the elastic body, said body is realized as a solid mass. This is advantageous if the coupling component part is subjected to alternating tensile and pressure loads. Furthermore, this type of body can be advantageously used if the distances between the two component parts that are to be connected are only small.

In another preferred embodiment of the coupling component part according to the invention, the fastening device is designed in such a way that is can be coupled by way of tying in with the respective component part. Preferably, the coupling component part according to the invention features an indentation arranged in the body that is suitable to engage a male tie-in section of the component part that is to be connected. In addition, the fastening device is equipped with a projection that protrudes beyond the indentation and which can serve as an additional fixed stop absorber.

In order to design the tie-in section on the coupling component part according to the invention with sufficient strength, it is possible to envision a reinforcement lining in the proximity of the indentation in the elastic body. Preferably, this reinforcement lining is completely covered by the material comprising the body, such as rubber or elastomer.

It should be understood that the component part according to the invention for coupling the two component parts can have a fastening device of the types respectively referred to previously. In particular, it is possible to envision combined fastening devices on respective coupling component parts. Correspondingly, this means one coupling element with a rivet element for fastening the one component part and a tie-in section for fastening the other component part or a combination comprised of a tie-in section and an engagement section are possible realizations of the coupling component part according to the invention.

Moreover, the invention relates to an apparatus with two component parts that are exposed to oscillations or vibrations during operation, in particular component parts of a motor vehicle. According to the invention, the apparatus is equipped with a coupling component part as represented above connecting the two component parts to each other. An apparatus of this kind according to the invention is essentially more flexible in terms of its design and its assembly than the conventional apparatuses of two component parts that are exposed to oscillations or vibrations during operation.

In a special realization, one of the component parts is a steering wheel skeleton part and the other component part is a damper element, in particular a gas generator for an airbag. To connect the two component parts to each other, it is possible to envision a support. One of the two component parts is rigidly connected to the support while the other component part is connected, spring-absorbing and/or canceling, via at least the one coupling component part. Due to the separate coupling component part according to the invention, there is a high level of flexibility during installation and with regard to the constructive design of the support as well as the component parts that are to be connected. In addition, the coupling component part according to the invention improves that apparatus according to the invention in that the two component parts can be directly connected to each other without interposition of a support. Because of the fact that the coupling component parts can be designed freely and dimension-specifically, it is possible to freely determine the coupling component parts as well as their arrangement and positioning with regard to the component parts and/or the support.

To allow the respective fastening device of the coupling component part according to the invention to act in conjunction with the respective component part that is to be connected, the component parts are correspondingly designed. Depending on the fastening device that is used, a component part is, for example, equipped with a hole or a bore hole for the fastening device consisting of a rivet element or a clip, a clamp gripper or a snapper for the engagement section or with a male tie-in section for the indentation that is arranged on the elastic body.

Furthermore, the invention relates to a support for holding one component part to another component part that is exposed to oscillations and/or vibrations, in particular a component part of a motor vehicle. On supports that are known in the art, elastic coupling parts are vulcanized to said supports. This results in only very minimal flexibility during the installation of the support with the respective component parts. The support according to the invention is equipped with coupling component parts of the kind according to the invention and pre-assembled, if necessary. To this end, the support can feature a hole or a bore hole for the fastening device comprised of a rivet element, a clamp gripper, clip or snapper for the engagement section of the elastic body and/or a male tie-in section for the indentation that is arranged on the elastic body. These constructive measures on the support according to the invention respectively act, exhibiting fastening properties, in conjunction with the coupling component part of the invention.

In particular, when the support according to the invention is used in the context of an oscillation apparatus comprised of a steering wheel skeleton part and a damper element constituted by the gas generator of an airbag module, the support according to the invention is equipped with an end opening that is essentially centrally arranged. In order to principally avoid having to carry out any vulcanization steps on the support, the elastic ring that is to be installed for the purpose of sealing the end opening is tied in with the circumference of the end opening. The gas generator can also be connected to the elastic ring, by way of tying it in, after the elastic ring has been positioned.

### DESCRIPTION OF THE DRAWINGS

Further advantages, characteristics and properties of the invention are illustrated in the context of the subsequent description of preferred embodiments thereof in connection with the accompanying drawings, and in which like numerals designate like elements.

FIG. 1a is a sectional view through a conventional steering apparatus;

FIG. 1b is a sectional view through another conventional steering apparatus;

FIG. 2 a longitudinal section of the coupling component part according to the invention in a first embodiment.

FIG. 3 a longitudinal section of the component part according to the invention in a second embodiment.

FIG. 4 a longitudinal section of the component part according to the invention in a third embodiment.

FIG. 5 a longitudinal section of the component part according to the invention in a fourth embodiment.

FIG. 6 a cross-section of the coupling component part in its installed state.

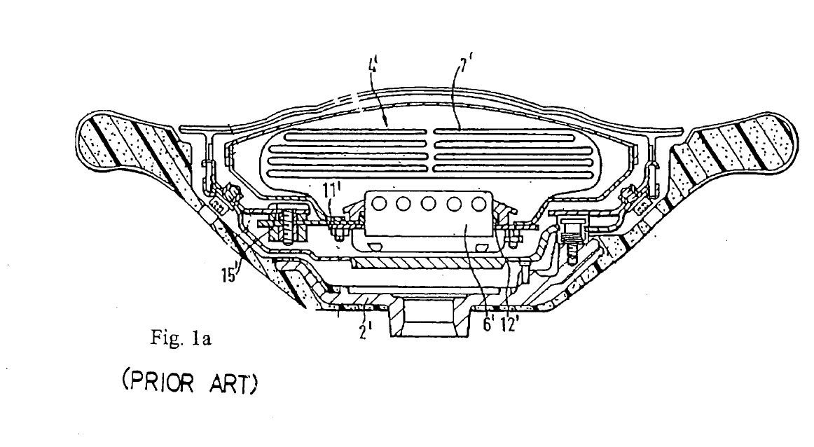

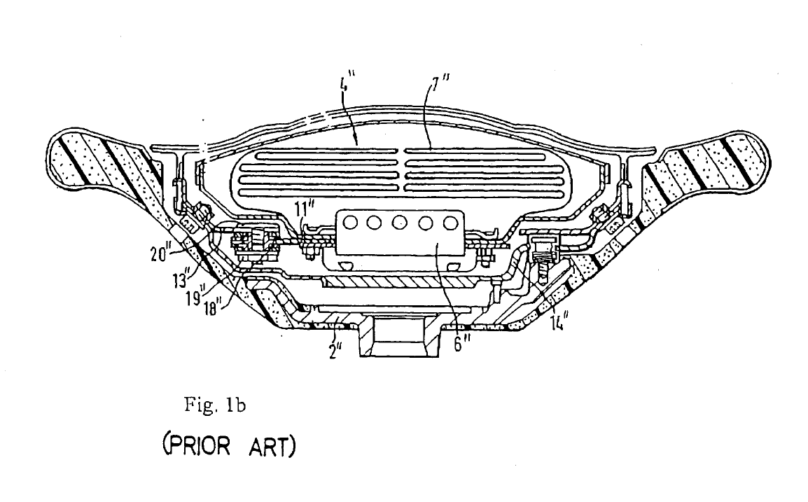

### DESCRIPTION OF PREFERRED EMBODIMENTS OF THE INVENTION

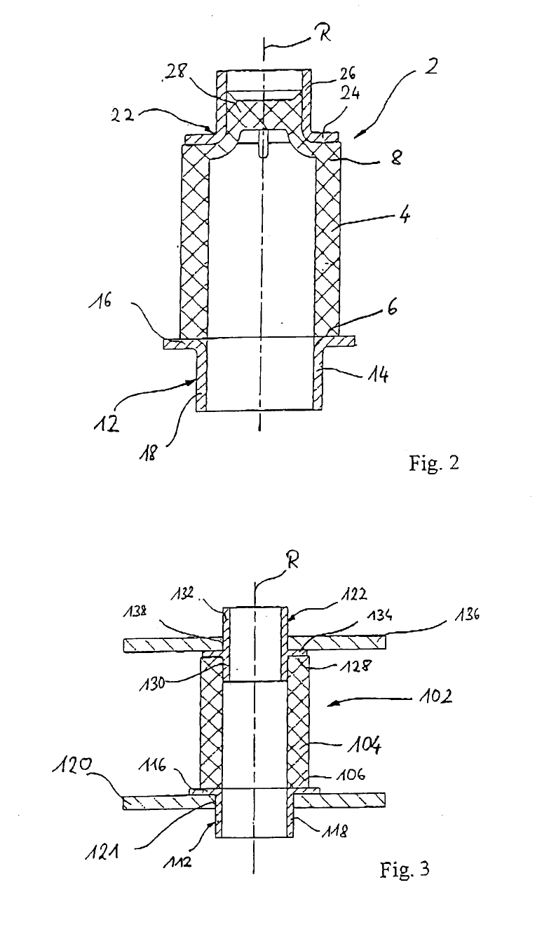

FIG. 2 shows a first embodiment of the coupling component part 2 according to the invention that comprises an elastic body 4. The elastic body 4 is formed of an elastomer the chemical composition of which is chosen in such a way that it is able to withstand the oscillations and/or vibrations that the coupling component part 2 is exposed to during operation. The body 4 has a rotation-symmetrical, sleeve-type construction 4 and extends along an axis of rotation R. The wall strength of the body 4 stays, starting from the lower end 6 of the body 4 in FIG. 2 to the upper section 8, constant. On the lower end 6 of the body 4, a first fastening device 12 is vulcanized to the latter. The fastening device 12 is realized as a rivet element suitable for fastening the coupling component part 2 to a motor vehicle component part, not shown in FIG. 2, that is exposed to oscillations and/or vibrations during operation.

The fastening device 12 is realized as a sleeved component part 14 with an L-shaped cross-section. The short leg of the L-shape 16 is securely fastened to the lower end 6 of the body 4. The long leg of the L-shape 18 extends in a longitudinal direction of the sleeve-type body 4. The long leg of the L-shape 18 of the sleeve-type component part 14 is radially turned up to the outside in order to fasten the coupling component part 2 to the motor vehicle component part that it is to be connected to. In this manner, the sleeve-shaped component part 14 functions as a rivet element. The inside diameter of the sleeve-shaped component part 14 corresponds to the inside diameter of the body 4 from the lower end 6 to the upper section 8.

A fastening device 22 for the coupling component part 2, also designed as a rivet element, is envisioned on the upper section 8 of the body 4, and this fastening device also has, in terms of its cross-section, an L-shaped, sleeve-type construction just as the fastening device 12. The short leg of the L-shape 24 of this sleeve-type construction is vulcanized to the elastic body in a crosswise direction relative to the longitudinal extension of the elastic body, and the long leg of the L-shape points away from the body 4 in a longitudinal direction. The inside diameter of the long leg of the L-shape 26 is smaller than the inside diameter of the long leg of the L-shape 18 of the fastening element 12 and of the part of the body 4 that extends from the lower end 6 to the upper section 8. The upper end 28 of the body 4 lines, in part, the inside surface of the sleeve-type construction of the fastening device 22 and is adapted to the form of the latter. The upper end 28 of the body 4 is closed and realized as reinforced.

The long leg of the L-shape 26 of the fastening device 22 protrudes beyond the end 28 of the body 4, and the long leg of the L-shape 26 can be turned up if it is to be connected to a further motor vehicle part (not shown).

FIG. 3 represents a further embodiment of the coupling component part 102 according to the invention; in the present context, identical and similar component parts are identified using the same reference symbols that are increased by 100 in the description of the figure for the purpose of improved legibility.

The elastic coupling component part 102 according to FIG. 3 comprises a sleeve-type body 104 the wall strength of which is constant along the entire length. The body 104 is rotation-symmetrical and extends lengthwise parallel in relation to the axis of rotation R. At its lower end 106 of the body 104, the fastening device 112 that has an L-shaped sleeve-type construction is vulcanized to the body. The inside diameter of the long leg of the L-shape 118 is identical to the inside diameter of the sleeve-type body 104. With its one side, the short leg of the L-shape 116 is in a direct contact position with the body 104 and the side that points away from the body 104 makes contact with a vehicle component part 120. The motor vehicle component part 120 can be part of the steering wheel skeleton.

The essentially constant outside diameter of the long leg of the L-shape 118 is minimally smaller than a diameter of a bore hole 121 that is arranged on the motor vehicle component part 120, thereby allowing the long leg of the L-shape 118 to be inserted through the bore hole 121. The section of the long leg of the L-shape 118 that protrudes through the bore hole 121 is used for the riveting process with the component part 120 in that the protruding section is turned up.

At the upper end of the body 104, a second fastening device 122 is securely attached to its upper end 128. The fastening device 122 features a sleeve-type construction, providing that a lower section 130 makes contact with the inside surface of the body 104 and an upper section 132 protrudes beyond the body 104. A fixed link 134, essentially arranged in a centered position and radially extending to the outside, is envisioned between the upper and lower sections 130, 132 and contacts the front side of the upper end 128 of the body 104. The fixed link is designed in one piece with the lower and upper sections 130, 132 of the fastening device 122. Moreover, the fixed link 134 serves as a stopper or contact surface for the further motor vehicle component part 136.

The fastening device 122 comprises a constant inside diameter that is smaller than the inside diameter of the body 104. The upper section 132 of the fastening device 122 has an outside diameter that is minimally smaller than a bore hole 138, which is arranged on the motor vehicle component part 136. This way, the upper section 132 of the fastening device 122 is inserted through the bore hole 138 for the purpose of installation, and the area of the upper section 132 protruding beyond the component part 136 can be turned up to rivet it to the motor vehicle component part 136.

The embodiment of the coupling component part according to the invention 102 that is shown in FIG. 3 realizes a connection of two motor vehicle component parts 120, 136 that are exposed to oscillations and/or vibrations during operation by way of utilizing mechanical fastening devices on the coupling component part in order to connect that part to the respective motor vehicle component parts 120, 136. Vulcanization steps required for the installation are no longer necessary with the coupling component parts 2, 120 according to the invention.

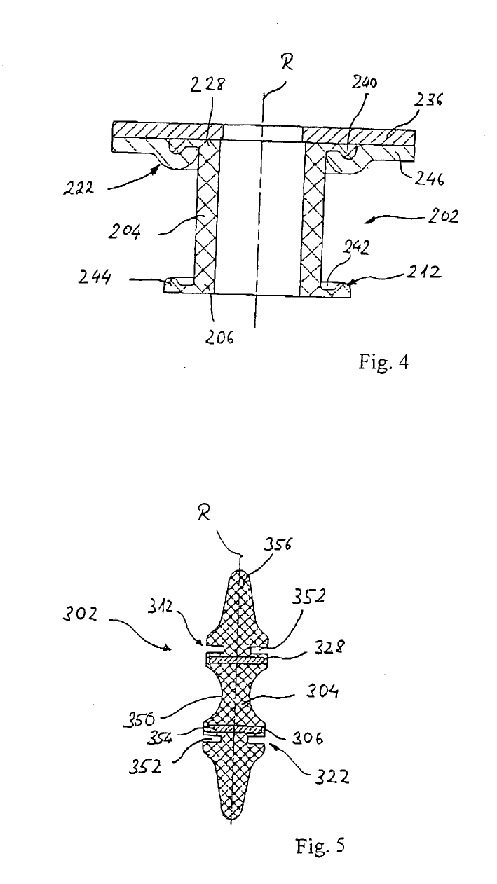

FIG. 4 represents a further embodiment of the coupling component part according to the invention; in the present context, identical and similar component parts are identified using the same reference symbols that are increased by 200 in the description of the figure for the purpose of improved legibility.

The coupling component part 202 according to FIG. 4 comprises a body 204 of an essentially sleeve-shaped construction. The wall strength of the body from the upper end 228 to the lower end 206 is essentially constant. The body is to be equipped with engagement sections 240, which are realized in one piece both at the upper end 228 as well as at the lower end 206, and said engagement sections extend radially toward the outside forming part of the respective fastening device 212, 222. The engagement sections 240 have a ring-shaped undercut 242, which is formed by way of the a ring-shaped roll 244 radially extending to the outside.

The fastening device 212, 222 that is created by the engagement section 240 acts in conjunction with a clamp gripper 246 or something similar, like a snapper. A clamp gripper 246 of this kind that acts upon the engagement section 240 on the upper end 228 of the body 204 is represented in FIG. 4. The clamp gripper 246 is securely connected to the motor vehicle component part 236 that is to be fastened, and the end of the clamp gripper 246 that is arranged in proximity of the body 204 is realized as hook-shaped in order to grip engagement section 240 while forming a positive and non-positive lock. A clamp gripper of this type can, naturally, also be envisioned at the lower end 206 of the body 204, which is not shown in FIG. 4.

FIG. 5 is a further preferred embodiment of the coupling component part according to the invention; in the present context, identical and similar component parts are identified using the same reference symbols that are increased by 300 in the description of the figure for the purpose of improved legibility.

The coupling component part 302 according to the invention in FIG. 5 features an elastic body 304 that is designed as solid body of a component part. From its lower end 306 to its upper end 328, the body 304 features a constriction 350 in order to withstand combined tensile stresses and pressure loads. A radial indentation is envisioned both at the upper end 228 as well as at the lower end 306 of the body 304 in order to constitute the respective fastening device 312, 322 into which the corresponding part of the motor vehicle component part (not shown) can be tied in. To reinforce the indentation 352, a metal lining 354 is envisioned on the side of an indentation that is pointed toward the side respectively opposite to the indentation 352. The metal lining 354 is completely covered by the elastomer material constituting the body 304.

Moreover, a roll-shaped protrusion 356 extends from the lining 354 and the indentation 352 in the lengthwise direction of the body 304. The roll-shaped protrusion 356 is intended to prevent any excessive stretching of the body 304 and/or the coupling component part 302. Fixed stop component parts are envisioned on the motor vehicle component part that is to be connected respectively (not shown) acting in conjunction with the protrusion 356 if the coupling component part 302 is excessively stretched.

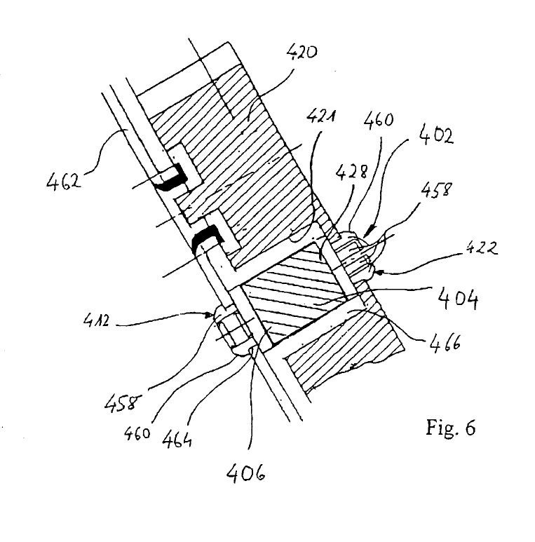

FIG. 6 represents a further embodiment of the coupling component part according to the invention; in the present context, identical and similar component parts are identified using the same reference symbols that are increased by 400 in the description of the figure for the purpose of improved legibility.

The coupling component part 402 according to the invention in correspondence with FIG. 6 has a body 404 that is comprised of an elastomer material. A fastening device 412 is envisioned both on the lower end 406 as well as on the upper end 428 and securely connected to the body 404. The elastic body 404 is designed as a solid body in the embodiment according to FIG. 6.

The fastening devices 412 are designed as plastic clips including several clamp hooks 458 that extend in the longitudinal direction of the coupling component part 402. In their installed state, the clamp hooks 458 are inserted through a bore hole in the motor vehicle component part, and they feature contact surfaces 460 on their ends that effect a compression of the hooks 458 during the inserting action. The bore hole of the motor vehicle component part is minimally smaller than the area of the hook 458 that is in the proximity of the body 404.

The motor vehicle component part in FIG. 6 represents a damper element 420 with a bore hole 421 that accommodates the coupling component part 402, which is, for the most part, surrounded by the damper element 420. The damper element 420 is connected to a support plate 462 via the coupling component part 402 according to the invention, and the coupling component part 402 according to the invention also features a bore hole 464 that is in a diametrically opposite position relative to the damper element 420. The diameter of the bore hole 464 is minimally smaller than the area of the hook 464 that is realized in the proximity of the body in order to realize a clamping action of the fastening device 412 with the support plate 462.

The fastening device 412 is realized as a plastic clip and can be comprised of any plastic material of sufficient strength to withstand the vibration stresses that acts upon the coupling component part 402 as well as upon the support plate 462 and the damper element 420.

The bore hole 421 in the damper element 420 has a first section with a large diameter that extends, for the most past, through the damper element and a second section with a smaller diameter that serves to interlock the clamping hook 458. A free space 466 is envisioned in the first section between the coupling component part 402 and the damper element 420.

In all four preferred embodiments, the body 4, 104, 204, 304, 404 is preferably comprised of an elastomer material, and the fastening devices 12, 22, 112, 122, which are designed as rivet elements, and the lining 354 of the tie-in fastening device in accordance with FIG. 5 are comprised of a metal, in particular of aluminum.

The characteristics disclosed in the above description of the figures can be individually significant or in any combination with regard to the realization of the invention.

What is claimed is:

1. Elastic coupling component part for connecting two component parts that are exposed to oscillations and/or vibrations during operation, in particular of a motor vehicle, preferably for connecting a steering wheel skeleton part and a damper element wherein the coupling component part comprises an elastic body and a mechanical fastening device, allocated to one component part respectively, that is securely fastened to the body.

2. Coupling component part as claimed in claim 1 wherein the fastening device is designed in such a way as to detachably fasten the coupling component part to the component parts.

3. Coupling component part as claimed in claim 1 wherein the fastening device is designed in such a way as to achieve a positive connection and/or a frictional or non-positive connection to the respective component part.

4. Coupling component part as claimed in claim 1 wherein the fasting device is envisioned on at least one free end of the coupling component part.

5. Coupling component part as claimed in claim 1 wherein the fastening device is comprised of a rivet element or a clip element.

6. Coupling component part as claimed in claim 5 wherein the rivet or clip elements are glued to or vulcanized to the elastic body.

7. Coupling component part as claimed in claim 5 wherein the rivet or clip element is comprised of a metal, in particular of aluminum.

8. Coupling component part as claimed in claim 1 wherein the fastening device is comprised of an engagement section arranged on the body with which the clamp gripper or snapper of one of the component parts is able to interact.

9. Coupling component part as claimed in claim 8 wherein the engagement section is realized in one piece with the body.

10. Coupling component part as claimed in claim 1 wherein the body has a sleeve-type construction.

11. Coupling component part as claimed in claim 1 wherein a massive elastic body is envisioned.

12. Coupling component part as claimed in claim 11 wherein the fastening device comprises an indentation that is arranged on the body and into which it is possible to tie the respective component part.

13. Coupling component part as claimed in claim 12 wherein the body has a reinforcement lining arranged adjacent to the indentation, which is completely covered, in particular, by the material that the body is comprised of.

14. Coupling component part as claimed in claim 1 wherein the body features an elastic projection that extends beyond the fastening device.

15. Coupling component part as claimed in claim 14 wherein the body and the protrusion are realized in one piece, in particular they are spray-molded.

16. Coupling component part as claimed in claim 1 wherein the body is comprised of rubber, in particular of an elastomer.

17. Apparatus as claimed in claim 1 with two component parts that are exposed to oscillations and/or vibrations during operation, in particular of a motor vehicle, and comprised of at least one elastic coupling component part in connecting the two component parts to each other.

18. Apparatus as claimed in claim 17 wherein the one component part is a steering wheel skeleton part and the other part is a damper element, in particular a gas generator for an airbag module.

19. Apparatus as claimed in claim 17 wherein a support is envisioned between the component parts and wherein one of the component parts is rigidly connected to the support and the other component parts is connected to the support via at least one coupling component part or both component parts are connected to the support via the at least one coupling component part.

20. Apparatus as claimed in claim 17 wherein both component parts are directly connected to each other via the at least the one coupling component part without interposition of a support.

21. Apparatus as claimed in claim 20 wherein the component parts are designed in such a way as to act in conjunction with the respective fastening device forming a mechanical connection.

22. Apparatus as claimed in claim 16 wherein at least one component part is equipped with a bore hole, a clamp gripper or snapper and/or a male tie-in section acting in conjunction with the respective fastening device of the coupling component part.

23. The support as claimed in claim 1 for holding a component part to another component part that is exposed to oscillations and/or vibrations during operation, in particular of a motor vehicle, wherein at least one coupling component part realized is securely mounted by way of its fastening device.

24. The support as claimed in claim 23 wherein at least one component part features at least one bore hole, one clamp gripper or snapper and/or one male tie-in section acting in conjunction with the respective fastening device of the coupling component part.

25. The support as claimed in claim 23 wherein the support features an end opening for the gas generator with an elastic ring tied into the circumference of the end opening.
